(19) United States
(12) Patent Application Publication
(10) Pub. No.: US 2001/0012157 A1
(43) Pub. Date: Aug. 9, 2001

(54) Spread illuminating apparatus

(75) Inventors: Shingo Suzuki, Iwata-gun (JP); Koichi Toyoda, Iwata-gun (JP)

Correspondence Address: OLIFF & BERRIDGE, PLC, 277 S. WASHINGTON STREET, SUITE 500, ALEXANDRIA, VA, 22314, US

(73) Assignee: Minebea Co., Ltd.

(21) Appl. No.: 09/772,851

(22) Filed: Jan. 31, 2001

(30) Foreign Application Priority Data
Feb. 8, 2000 (JP) 2000-030540

(51) Int. Cl. G02B 23/00

(52) U.S. Cl. 359/599; 359/431; 359/707

(57) ABSTRACT

There is provided a spread illuminating apparatus which is improved in terms of compactness. A transparent substrate (2A) is composed of a transparent substrate proper (15), a curve (16) and an extension (17) which is plate-like, continuous with the curve (16) and substantially perpendicular to the transparent substrate proper (15). Light rays from a spot-like light source (6) enter the extension (17). Thereafter, the light rays enter the transparent substrate proper (15) due to the total internal reflection at the extension (17) and the curve (16), the reflection at a curved surface (16a) of the curve (16), and the like. Thus the light rays enter the transparent substrate proper (15) with the spot-like light source (6) not disposed on the same plane as the transparent substrate proper (15). Therefore, the spot-like light source (6) is subjected to reduced restrictions in arrangement, thereby enabling the spot-like light source (6) to be disposed on the same electric wiring board (14) together with other electronic components, whereby the apparatus can be made compact.

### BACKGROUND OF THE INVENTION

1. Field of the Invention

The present invention relates to a spread illuminating apparatus used as an illuminating means for signboards, various kinds of reflection-type display devices and the like, and more particularly to a spread illuminating apparatus used as an illuminating means for a liquid crystal display device.

2. Description of the Related Art

A demand for a liquid crystal display device as a display device mainly for computers has been increasing since the liquid crystal display device which operates with low power consumption is characterized by being thin and lightweight. Since a liquid crystal which is a component of the liquid crystal display device does not emit light by itself unlike a light emitting element such as a picture tube, an illuminating means for viewing an image is required. In particular, in the recent demand for thinner devices, there is a growing tendency to employ a thin plate-like spread illuminating apparatus of side light type (light conductive plate type) as an illuminating means for the liquid crystal display device.

An example of such a side light type spread illuminating apparatus is shown in FIGS. 12 and 13.

In FIGS. 12 and 13, this spread illuminating apparatus 1 is generally constituted such that a bar-like light source 4 is disposed close to one end surface 3 of a transparent substrate 2 made of a light-transmissible material. The transparent substrate 2 is formed in a wedge-shape, in which as the distance from the end surface 3 increases, the thickness of the transparent substrate 2 gradually degreases.

The light source 4 is generally composed of a light conductive member 5 and a spot-like light source 6. The light conductive member 5 is made of a transparent material, formed in a long plate-shape and disposed close to and along the end surface 3 of the transparent substrate 2, and the spot-like light source 6 is composed of an LED and disposed facing one end 5a of the light conductive member 5. A reflection plate 7 is disposed facing the other end 5b of the light conductive member 5.

Further, a light reflection member 9, which is substantially U-shaped, is disposed in such a manner as to cover longitudinal surfaces of the light conductive member 5 except a surface facing the transparent substrate 2 (first surface 5c of the light conductive member) [covered are a surface opposing the first surface 5c of the light conductive member (second surface 5d of the light conductive member), and two surfaces extending in the longitudinal direction which are perpendicular to and continuous with the second surface 5d of the light conductive member (the one on the upper side in FIG. 12 is referred to as third surface 5e of the light conductive member, and the one on the lower side in FIG. 12 is referred to as fourth surface 5f of the light conductive member)] and a transparent substrate proximal portion 8, that is, a portion toward the end surface 3 of the transparent substrate 2.

A double-faced adhesive tape 10 is placed between the transparent substrate proximal portion 8 and both opposing plates 9a and 9b of the light reflection member 9 which are facing each other, whereby the light reflection member 9 is fixed to the transparent substrate proximal portion 8.

A light reflection pattern 12 is formed on a surface 11 of the transparent substrate 2 (the upper side in FIG. 12, and hereinafter referred to as upper surface), and thus the brightness is substantially uniform everywhere on the transparent substrate 2 irrespective of the distance from the light conductive member 5.

In the spread illuminating apparatus, it is desired that the spot-like light source be disposed on an electric wiring board (not shown) together with other electronic components in order to make the apparatus as compact as possible.

However, according to the conventional art shown in FIGS. 12 and 13 as described above, a reflection-type liquid crystal display element and so on are disposed under the spread illuminating apparatus, accordingly there necessarily exists a distance corresponding to the thickness of the liquid crystal display element and so on between the spread illuminating apparatus and the electric wiring board. Therefore, it is difficult to dispose the spot-like light source 6 composed of an LED together with other electronic components (electronic components used for an electronic equipment provided with the liquid crystal display element, not shown) on the same electric wiring board (not shown), which requires the provision of separate wiring paths. Since the separate wiring paths are provided in the above-described conventional art, the circuit structure is complicated, thereby obstructing miniaturization.

### SUMMARY OF THE INVENTION

The present invention has been made in view of the above, and an object of the present invention is therefore to provide a spread illuminating apparatus which is improved in terms of miniaturization.

According to a first aspect of the present invention, there is provided a spread illuminating apparatus in which a bar-like light source is disposed in the vicinity of an end surface of a transparent substrate made of a light-transmissible material, characterized in that a turn portion which changes the direction of light rays is provided continuously with the end surface of the transparent substrate.

According to a second aspect of the present invention, in the spread illuminating apparatus of the first aspect of the invention, the turn portion has a curve shape.

According to a third aspect of the present invention, in the spread illuminating apparatus of the second aspect of the invention, the turn portion includes a flat reflective surface provided at its outer face.

According to a fourth aspect of the present invention, in the spread illuminating apparatus of the first aspect of the invention, the turn portion has a bend shape and includes a curved surface or a flat reflective surface provided at its outer face.

According to a fifth aspect of the present invention, in the spread illuminating apparatus of any one of the first to fourth aspects of the invention, the turn portion is provided with a means for increasing reflection which improves light reflectance.

According to a sixth aspect of the present invention, in the spread illuminating apparatus of the first aspect of the invention, a first optical path conversion means which changes the direction of light rays from the light source and makes the light rays enter the transparent substrate is provided in place of the turn portion separately from the transparent substrate and disposed toward the end surface of the transparent substrate.

According to a seventh aspect of the present invention, in the spread illuminating apparatus of the sixth aspect of the invention, the first optical path conversion means is provided with a means for increasing reflection which improves light reflectance.

According to an eighth aspect of the present invention, in the spread illuminating apparatus of any one of the first to fifth aspects of the invention, a second optical path conversion means which changes the direction of light rays is provided at an end surface of the turn portion facing the light conductive member.

According to a ninth aspect of the present invention, in the spread illuminating apparatus of the sixth or seventh aspect of the invention, the second optical path conversion means which changes the direction of light rays is provided at an end surface of the first optical path conversion means facing the light conductive member.

### BRIEF DESCRIPTION OF THE DRAWINGS

In the accompanying drawings:

FIG. 1 is an exploded perspective view showing a spread illuminating apparatus according to a first embodiment of the present invention;

FIG. 2 is a schematic diagram showing the courses of light rays of the spread illuminating apparatus in FIG. 1;

FIG. 3 is an exploded perspective view showing a spread illuminating apparatus according to a second embodiment of the present invention;

FIG. 4 is a schematic diagram showing the courses of light rays of the spread illuminating apparatus in FIG. 3;

FIG. 5 is an exploded perspective view showing a spread illuminating apparatus according to a third embodiment of the present invention;

FIG. 6 is a schematic diagram showing the courses of light rays of the spread illuminating apparatus in FIG. 5;

FIG. 7 is an exploded perspective view showing a spread illuminating apparatus according to a fourth embodiment of the present invention;

FIG. 8 is a schematic diagram showing the courses of light rays of the spread illuminating apparatus in FIG. 7;

FIG. 9 is a schematic diagram showing a spread illuminating apparatus according to a fifth embodiment of the present invention;

FIG. 10 is an exploded perspective view showing an example of a spread illuminating apparatus for comparison with the present invention;

FIG. 11 is a schematic diagram showing the courses of light rays of the spread illuminating apparatus in FIG. 10;

FIG. 12 is an exploded perspective view showing an example of a conventional spread illuminating apparatus; and

FIG. 13 is a perspective view showing the spread illuminating apparatus in FIG. 12 in the assembled state.

### DETAILED DESCRIPTION OF THE PREFERRED EMBODIMENTS

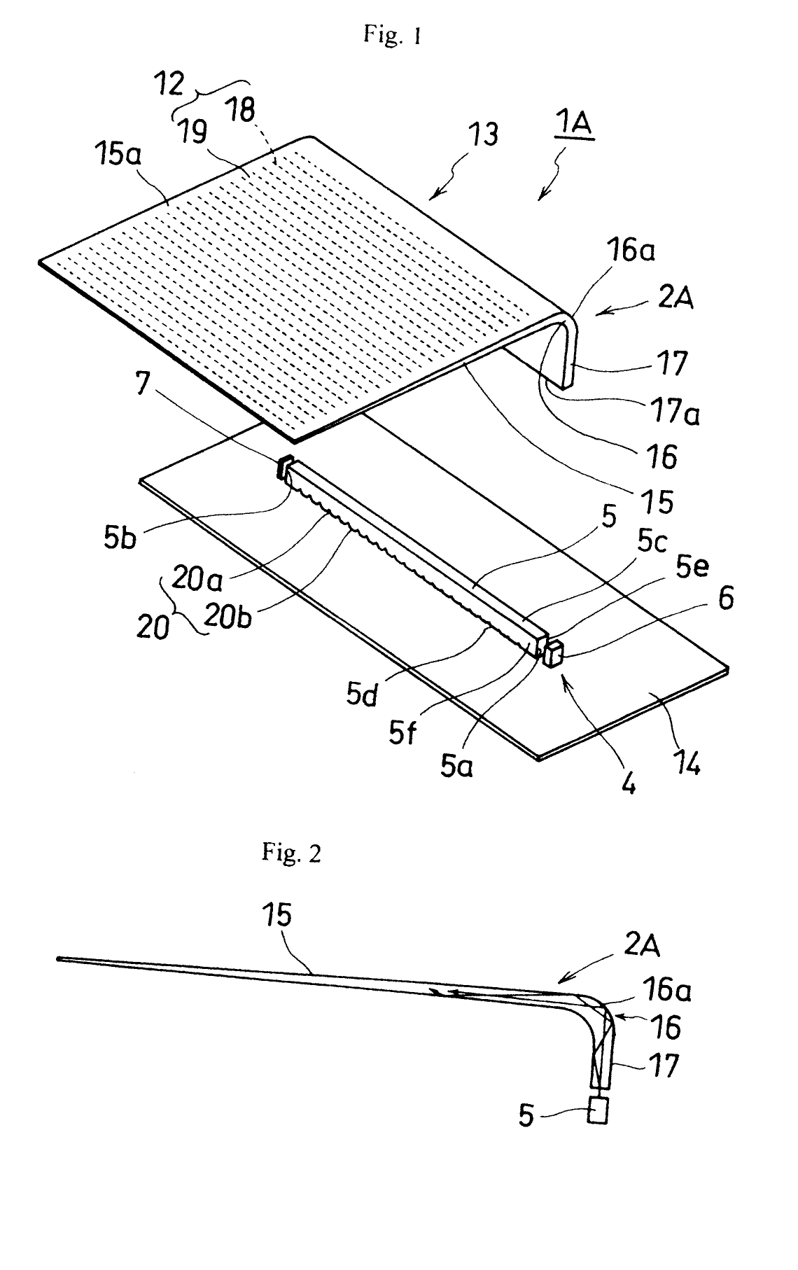

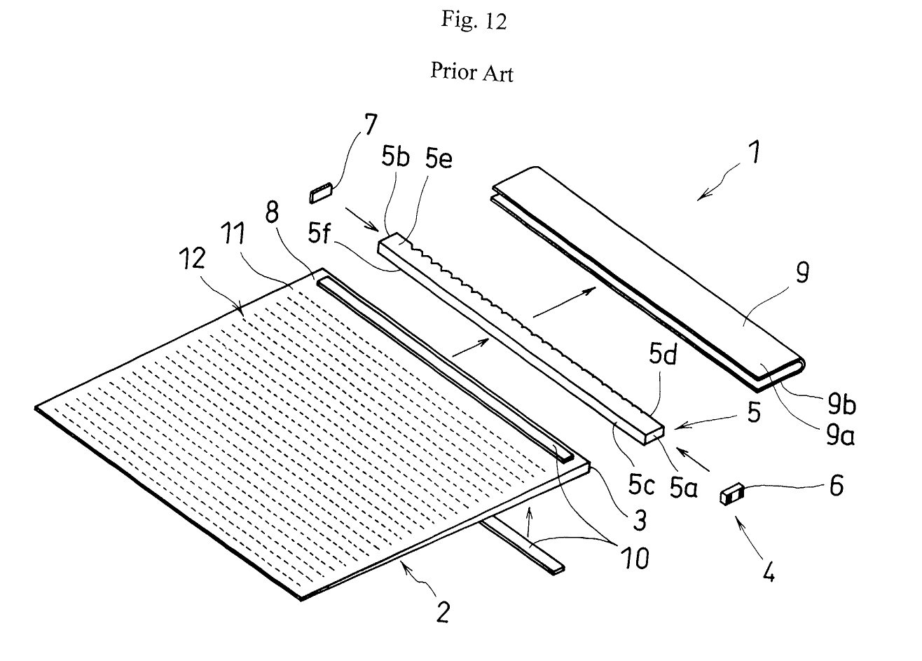

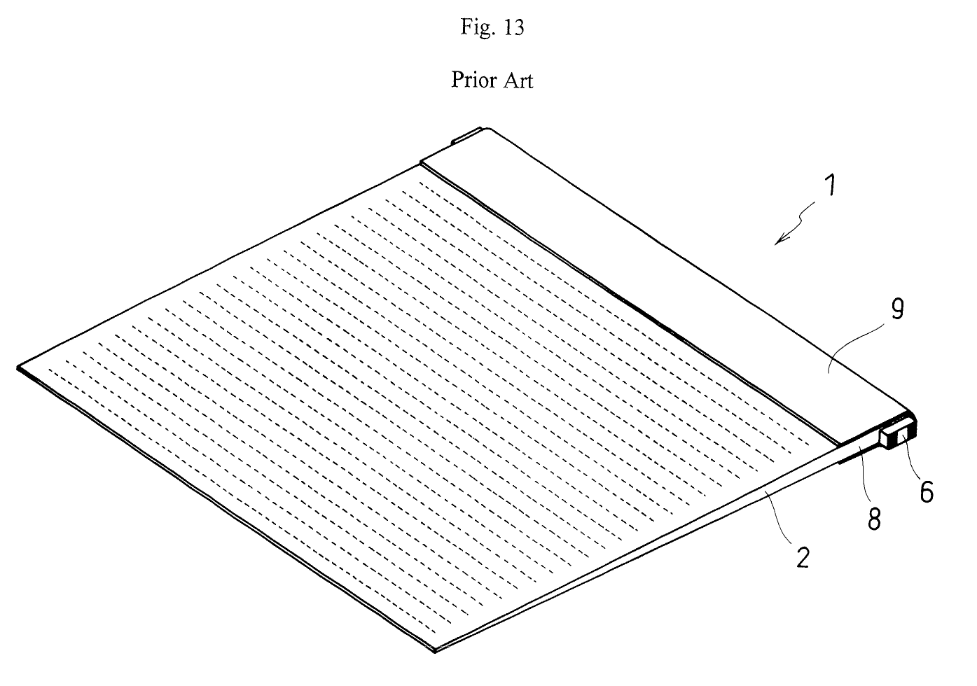

A spread illuminating apparatus 1A according to a first embodiment of the present invention will be described with reference to FIGS. 1 and 2. Note that parts and components identical with those in FIGS. 12 and 13 are designated by the same numerals and the description thereof will be appropriately omitted.

The spread illuminating apparatus 1A is generally composed such that a bar-like light source 4 is disposed close to one end surface 13 (light incident surface) of a transparent substrate 2A made of a light-transmissible material. For instance, the spread illuminating apparatus 1A is disposed in such a manner as to cover a viewing surface of a reflection-type liquid crystal display element (not shown), and used as an auxiliary illuminating apparatus for the liquid crystal display element.

A spot-like light source 6 composed of an LED, a light conductive member 5 and a reflection plate 7 are disposed on an electric wiring board 14 together with electronic components (not shown). In this case, the light conductive member 5 is disposed such that a second surface 5d of the light conductive member faces the electric wiring board 14 and that a first surface 5c of the light conductive member is exposed in parallel with the electric wiring board 14.

The transparent substrate 2A is generally composed of a transparent substrate proper 15 which has a rectangular shape in plan view, a curve 16 (turn portion) which is formed toward the end surface 13 of the transparent substrate proper 15 and an extension 17 which is plate-like, continuous with the curve 16 and substantially perpendicular to the transparent substrate proper 15. A tip end surface 17a of the extension 17 faces the first surface 5c of the light conductive member 5. A curved surface 16a is formed at the outer face of the curve 16 (the upper right side in FIG. 2). The transparent substrate proper 15 is formed in a wedge-shape, in which as the distance from the end surface 13 increases, the thickness of the transparent substrate proper 15 gradually decreases.

A light reflection pattern 12 is formed on a surface of the transparent substrate proper 15 (the upper side in FIG. 1, and hereinafter referred to as upper surface 15a). The light reflection pattern 12 is composed of a number of grooves 18 each of which has a substantially triangular shape in section, and a number of flat portions 19 each of which is formed between two adjacent grooves 18. Thus, the light reflection pattern 12 is designed in such a manner that the ratio of the width (occupied area) of the groove 18 to the width (occupied area) of the flat portion 19 becomes gradually larger as the distance from the end surface 13 increases so that the brightness is substantially uniform everywhere on the transparent substrate proper 15 irrespective of the distance from the light conductive member 5.

The grooves 18 of the light reflection pattern 12 formed on the transparent substrate proper 15 are so fine that the grooves 18 are no obstacles to viewing the screen.

An optical path conversion means 20 is provided on the second surface 5d of the light conductive member 5. The optical path conversion means 20 is composed of grooves 20a each of which is substantially triangular in section, and flat portions 20b each of which is formed between two adjacent grooves 20a.

Light rays which travel inside the light conductive member 5 and are reflected at the second surface 5d thereof have a tendency, when reflected at the grooves 20a, to travel substantially perpendicular to the first surface 5c because of an inclined surface (not shown) constituting the groove 20a, and a larger amount of light is adapted to penetrate the first surface 5c of the light conductive member and resultingly travels into the transparent substrate 2A compared with when reflected at the flat portions 20b. Accordingly, the ratio of the width (occupied area) of the groove 20a to the width (occupied area) of the flat portion 20b is set in such a manner as to become gradually larger as the distance from the end 5a of the light conductive member 5 increases. At this point, the optical path conversion means 20 is formed in consideration of the distance from the spot-like light source 6 and the balance of the occupied area of the groove 20a, whereby the light rays are uniformly radiated at the first surface 5c of the light conductive member although the spot-like light source 6 is disposed at the one end 5a.

In order to concretely vary the ratio of the occupied area of the groove 20a to the occupied area of the flat portion 20b as described above, the optical path conversion means 20 in this embodiment is set such that the interval (pitch) between one groove 20a and its adjacent groove 20a is kept constant while the depth of a cut in the groove 20a gradually increases as the distance from the spot-like light source 6 increases. Note that, although not shown in the figure, the optical path conversion means 20 may be set such that the depth of the cut in the groove 20a is kept constant while the interval (pitch) between one groove 20a and its adjacent groove 20a is set in such a manner as to gradually decrease, whereby the ratio of the occupied area of the groove 20a to the occupied area of the flat portion 20b is varied.

In the spread illuminating apparatus 1A structured as described above, light rays from the spot-like light source 6 enter the light conductive member 5, go through the first surface 5c of the light conductive member, and then enter the extension 17 of the transparent substrate 2A. Thereafter, the light rays enter the transparent substrate proper 15 due to the total internal reflection at the extension 17 and the curve 16, the reflection at the curved surface 16a, and the like.

Namely, light rays which are out of the light rays from the spot-like light source 6 and travel toward the upper side in FIG. 2 are reflected at the curved surface 16a formed at the outer face of the curve 16 (the upper right side in FIG. 2), etc., whereby the light rays are directed toward the transparent substrate proper 15 to enter the transparent substrate proper 15.

As described above, the curve 16 (turn portion) and the extension 17 are provided toward the light incident surface of the transparent substrate 2A to thereby change the direction of the light rays from the light source 4. Thus the light rays from the spot-like light source 6 enter the transparent substrate proper 15 with the spot-like light source 6 not disposed on the same plane as the transparent substrate proper 15. Therefore, the spot-like light source 6 is under less restrictions in arrangement, thereby enabling the spot-like light source 6 and other electronic components (not shown) to be disposed together on the same electric wiring board 14.

In the conventional art described above referring to FIGS. 12 and 13, it is difficult to dispose the spot-like light source 6 on the same electric wiring board together with other electronic components (not shown), and separate wiring paths have to be provided making the circuit structure complicated. Now, according to this embodiment of the present invention, the spot-like light source 6 and other electronic components (not shown) may be disposed together on the same electric wiring board 14, whereby the apparatus can be made compact.

In the first embodiment described above, a second optical path conversion means (not shown), which changes the direction of light rays similarly to the optical path conversion means 20 described above, may be provided on the tip end surface 17a of the extension 17 (end surface of the turn portion facing the light conductive member). Such a structure enables light rays from a light source to be guided satisfactorily to an exit side. Therefore, the second optical path conversion means can function as a light conductive member as well, so the number of components can be reduced.

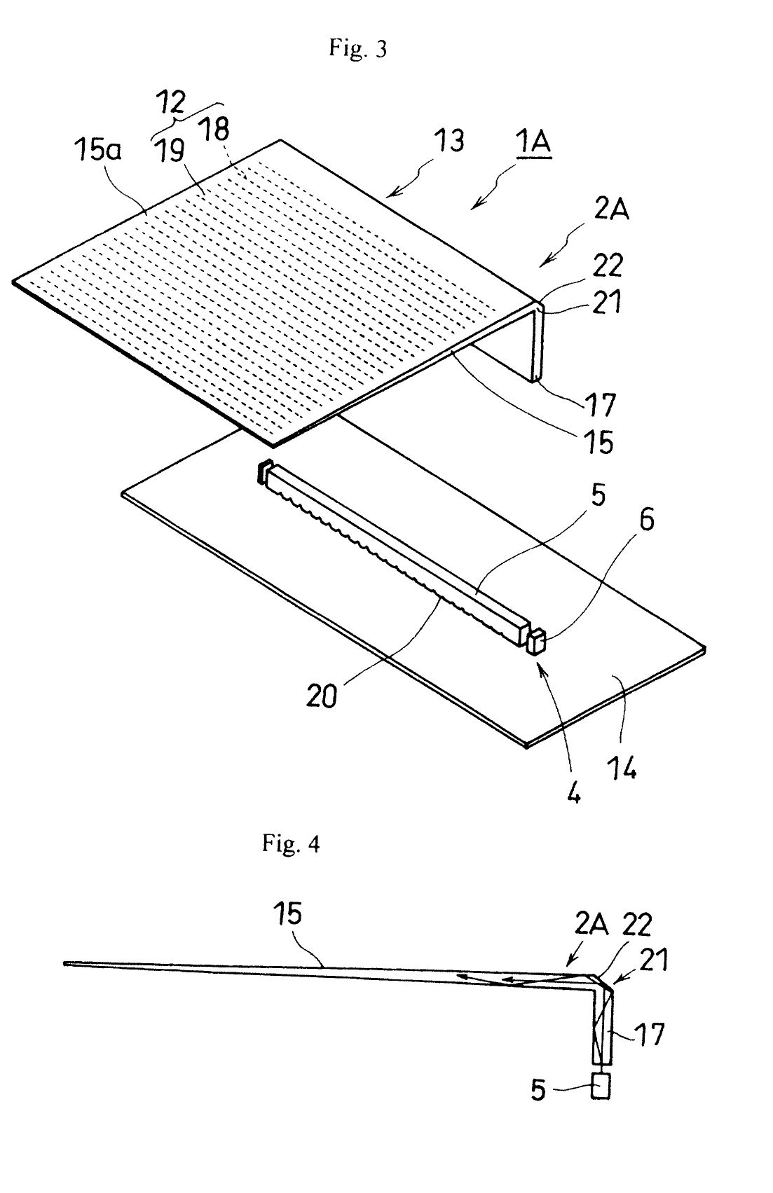

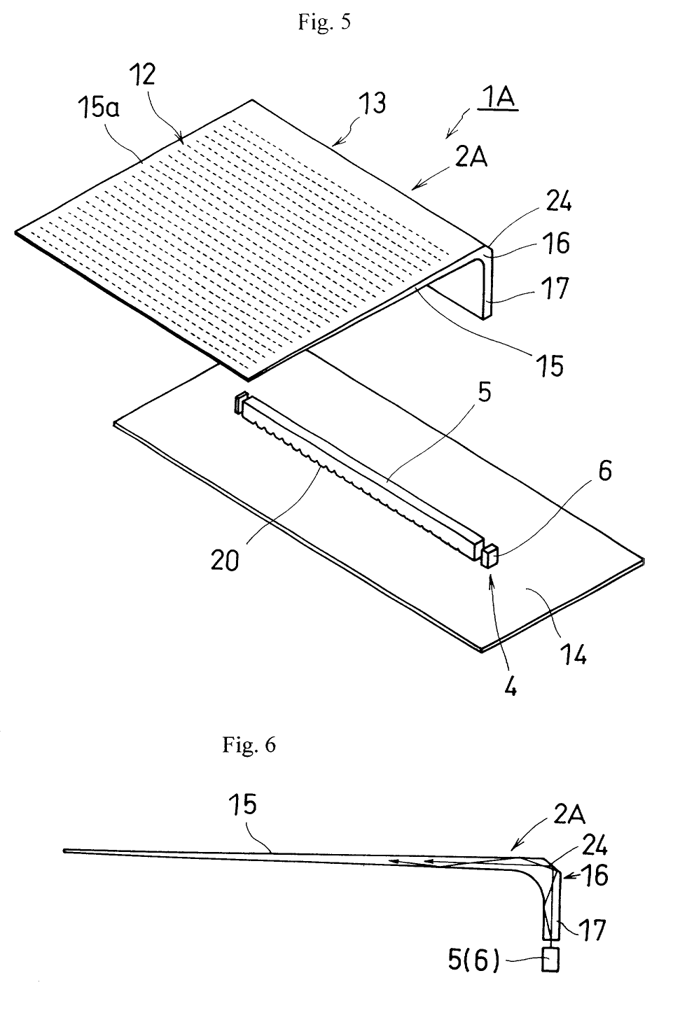

Instead of the first embodiment described above, the present invention may take a structure shown in FIGS. 3 and 4 (hereinafter referred to as second embodiment) or a structure shown in FIGS. 5 and 6 (hereinafter referred to as third embodiment).

As shown in FIGS. 3 and 4, the second embodiment is different from the first embodiment in that a bend 21 (turn portion) which is bent substantially at a right angle and which includes a flat reflective surface 22 provided in place of the curved surface 16a formed at the outer face of the curve 16 (turn portion) (the upper right side in FIG. 2) is provided in place of the curve 16 (turn portion).

In this second embodiment, light rays from the spot-like light source 6 enter the extension 17 of the transparent substrate 2A, and then enter the transparent substrate proper 15 due to the total internal reflection at the extension 17 and the bend 21, the reflection at the reflective surface 22, etc. Light rays which are out of the light rays from the spot-like light source 6 and travel toward the upper side in FIG. 4 are reflected at the reflective surface 22, etc., whereby the light rays are directed toward the transparent substrate proper 15 to enter the transparent substrate proper 15.

As described above, the bend 21 (turn portion) and the extension 17 are provided toward the light incident surface of the transparent substrate 2A to thereby change the direction of the light rays from a light source 4. Thus the light rays from the spot-like light source 6 enter the transparent substrate proper 15 with the spot-like light source 6 not disposed on the same plane as the transparent substrate proper 15. Therefore, the spot-like light source 6 is under less restrictions in arrangement, thereby enabling the spot-like light source 6 to be disposed on the same electric wiring board 14 together with other electronic components (not shown).

Further, since the spot-like light source 6 and other electronic components (not shown) may be disposed together on the same electric wiring board 14, the apparatus can be made compact as in the first embodiment described above.

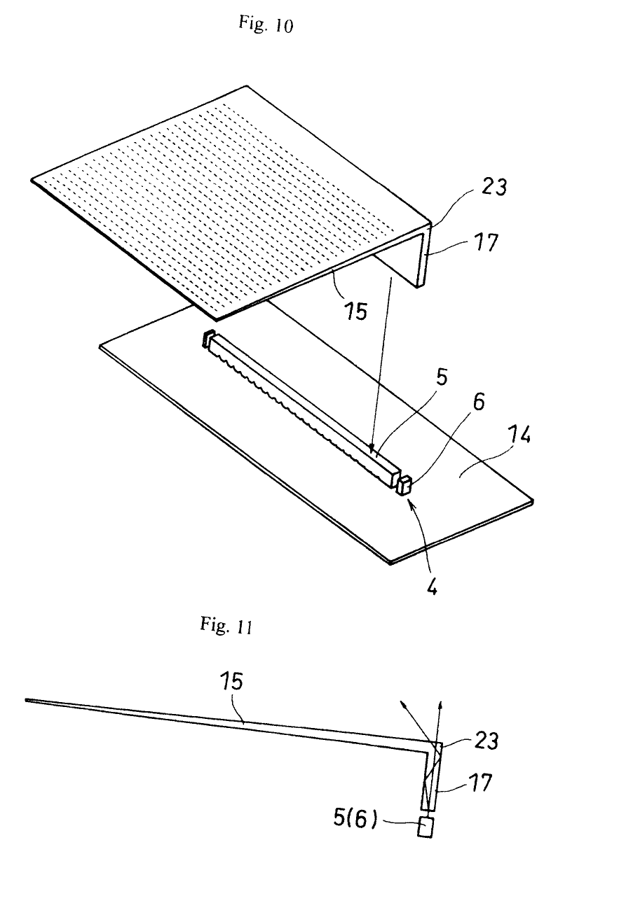

Note that, as shown in FIGS. 10 and 11, a plain bend 23 which is bent substantially at a right angle may be provided in place of the curve 16 (turn portion) of the first embodiment. In addition, in the spread illuminating apparatus shown in FIGS. 10 and 11, the spot-like light source 6 and other electronic components (not shown) may be disposed together on the same electric wiring board 14. With such a structure, however, light rays which are out of the light rays from the spot-like light source 6 and travel toward the upper side in FIG. 11 exit out the bend 23 and go away in the upward direction in FIG. 11 without entering the transparent substrate proper 15. Thus, the light rays from the spot-like light source 6 are not fully utilized deteriorating the efficiency of using light rays compared to the second embodiment.

As shown in FIGS. 5 and 6, the third embodiment is different from the first embodiment in that a flat reflective surface 24 is provided in place of the curved surface 16a formed at the outer face of the curve 16 (turn portion) (the upper right side in FIG. 2).

In this third embodiment, light rays from the spot-like light source 6 enter an extension 17 of the transparent substrate, and then enter the transparent substrate proper 15 due to the total internal reflection at the extension 17 and the curve 16, the reflection at the reflective surface 24, and the like. Light rays which are out of the light rays from the spot-like light source 6 and travel toward the upper side in FIG. 6 are reflected at the reflective surface 24, etc., whereby the light rays are directed toward the transparent substrate proper 15 to enter the transparent substrate proper 15.

As described above, the curve 16 (turn portion) and the extension 17 are provided toward the light incident surface of the transparent substrate 2A to thereby change the direction of the light rays from the light source 4. Thus the light rays from the spot-like light source 6 enter the transparent substrate proper 15 with the spot-like light source 6 not disposed on the same plane as the transparent substrate proper 15. Therefore, the spot-like light source 6 is under less restrictions in arrangement, thereby enabling the spot-like light source 6 to be disposed on the same electric wiring board 14 together with other electronic components (not shown).

Further, since the spot-like light source 6 and other electronic components (not shown) may be disposed together on the same electric wiring board 14, the apparatus can be made compact as in the first embodiment described above.

In the first, second and third embodiments described above, a layer (not shown) or a film (not shown) may be provided at the turn portion (curve 16 or bend 21) as a means for increasing reflection in order to improve light reflectance.

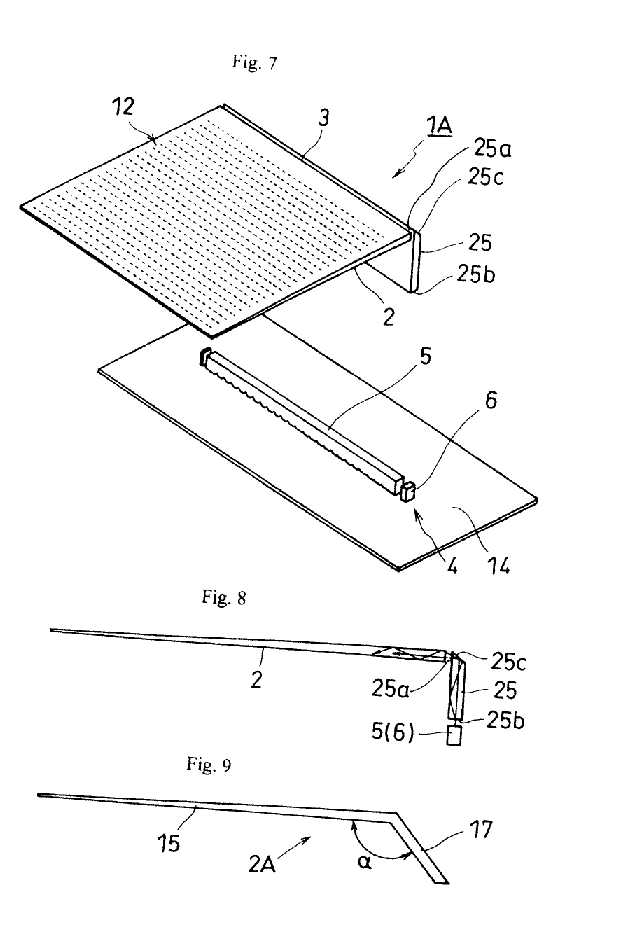

In the first, second and third embodiments described above, the transparent substrate 2A is integrally composed of the transparent substrate proper 15, the turn portion (curve 16 or bend 21) and the extension 17. However, as shown in FIGS. 7 and 8, a portion comprising the turn portion and the extension 17 in the first, second and third embodiments may be separately provided from the transparent substrate proper 15 (hereinafter referred to as fourth embodiment).

Namely, a direction changing plate 25 as a first optical path conversion means, which changes the direction of light rays from the light conductive member 5 and makes the light rays enter a transparent substrate 2, is provided at one end surface 3 (light incident surface) of the transparent substrate 2 composed similarly to a transparent substrate 2 in FIGS. 12 and 13. The direction changing plate 25 is disposed substantially at right angles with the transparent substrate 2. One end 25a (the upper side in FIG. 8) of the direction changing plate 25 overlaps the light incident surface of the transparent substrate 2, and the other end 25b (the lower side in FIG. 8) faces the light conductive member 5.

A reflective surface 25c inclined about 45 degrees to the transparent substrate 2 is formed at the end 25a of the direction changing plate 25 with the side farther from the transparent substrate 2 (the upper right side in FIG. 8) positioned downward to thereby change the direction of the light rays coming from the light conductive member 5 toward the transparent substrate 2.

In this fourth embodiment, in the almost same way as the above respective embodiments (first, second and third embodiments), light rays from the spot-like light source 6 which have entered the direction changing plate 25 are reflected at the reflective surface 25c, etc., whereby the light rays are directed toward the transparent substrate 2 to enter the transparent substrate 2.

In the fourth embodiment described above, a layer (not shown) or a film (not shown) may be provided at the reflective surface 25c as a means for increasing reflection in order to improve light reflectance. By taking such a means, the light reflectance is improved, and the efficiency of using light from a light source can be further enhanced.

As described above, the direction changing plate 25 is provided in such a manner as to face the transparent substrate 2 to thereby change the direction of light rays from a light source 4. Thus the light rays from the spot-like light source 6 enter the transparent substrate 2 with the spot-like light source 6 not disposed on the same plane as the transparent substrate 2. Therefore, the spot-like light source 6 is under less restrictions in arrangement, thereby enabling the spot-like light source 6 to be disposed on the same electric wiring board 14 together with other electronic components (not shown).

Further, since the spot-like light source 6 and other electronic components (not shown) may be disposed together on the same electric wiring board 14, the apparatus can be made compact as in the respective embodiments described above.

Also, in the fourth embodiment, the transparent substrate 2 and the direction changing plate 25 are separately formed, whereby they can be manufactured more easily compared with the case where the turn portion, the extension and the transparent substrate are integrally formed.

In the fourth embodiment described above, a second optical path conversion means (not shown), which changes the direction of light rays similarly to the optical path conversion means 20 described above, may be provided on a surface (facing the light conductive member) of the other end 25b of the direction changing plate 25. Such a structure enables light rays from a light source to be guided satisfactorily to an exit side. Therefore, the second optical path conversion means can function as a light conductive member as well, so the number of components can be reduced.

In the first, second and third embodiments described above, the extension 17 is substantially perpendicular to the transparent substrate proper 15. However, the present invention is not limited to this. For example, it may be structured such that the extension 17 has an obtuse angle α to the transparent substrate proper 15 as shown in FIG. 9 (fifth embodiment).

Moreover, in each of the above embodiments, a light-emitting diode is used for the spot-like light source 6, but there is no limitation on this. For example, an incandescent lamp that can be lit with a relatively low voltage may also be used.

Further, in each of the above embodiments, the light source 4 is composed of the light conductive member 5 and the spot-like light source 6. Instead of this, a bar-like light source lamp such as a cold cathode fluorescent lamp (CCFL) or hot cathode fluorescent lamp (HCFL) may be used as a light source, and the present invention may be applied to a spread illuminating apparatus in which this bar-like light source lamp is disposed close to one end surface of a transparent substrate.

Furthermore, in the embodiments of the present invention, the transparent substrate proper 15 is formed in a wedge-shape, in which as the distance from the end surface 13 increases, the thickness of the transparent substrate proper 15 gradually decreases. This construction is desirable for making the apparatus thinner and lighter in weight. Alternatively, the transparent substrate proper 15 may be formed with a uniform thickness.

According to any one of the first to fifth aspects of the present invention, the turn portion is provided at the one end surface (light incident surface) of the transparent substrate to thereby change the direction of the light rays from the light source. Thus the light rays from the spot-like light source enter the transparent substrate proper with the spot-like light source not disposed on the same plane as the transparent substrate proper. Therefore, the light source is under less restrictions in arrangement, thereby enabling the spot-like light source to be disposed on the same electric wiring board together with other electronic components. In the conventional art, it has been difficult to dispose the spot-like light source and other electronic components on the same electric wiring board, and separate wiring paths have to be provided making the circuit structure complicated. On the other hand, according to the present invention, the light source and other electronic components may be disposed together on the same electric wiring board as described above, whereby the apparatus can be made compact. Note that, according to the fifth aspect of the present invention, the means for increasing reflection is provided at the turn portion, to thereby improve light reflectance. Accordingly, the efficiency of using light from the light source can be enhanced.

According to the sixth or seventh aspect of the present invention, the transparent substrate and the second optical path conversion means are formed separately. Thus, they can be manufactured more easily, compared with the case where means for changing the direction of light rays from a light source is integrally formed with, for example, the transparent substrate. Note that, according to the seventh aspect of the present invention, the means for increasing reflection is provided at the first optical path conversion means to thereby improve the light reflectance. Accordingly, the efficiency of using light from the light source can be enhanced.

According to the eighth or ninth aspect of the present invention, the second optical path conversion means which changes the direction of light rays is provided on the end surface of the turn portion facing the light conductive member or the end surface of the first optical path conversion means facing the light conductive member. Thus, light rays from the light source are guided satisfactorily to an exit side. Therefore, the second optical path conversion means can function as a light conductive member as well, so the number of components can be reduced.

What is claimed is:

1. A spread illuminating apparatus in which a bar-like light source is disposed in the vicinity of an end surface of a transparent substrate made of a light-transmissible material, characterized in that a turn portion which changes the direction of light rays is provided continuously with the end surface of said transparent substrate.

2. A spread illuminating apparatus as claimed in claim 1, wherein said turn portion has a curve shape.

3. A spread illuminating apparatus as claimed in claim 2, wherein a flat reflective surface is provided at an outer face of said turn portion.

4. A spread illuminating apparatus as claimed in claim 1, wherein said turn portion has a bend shape and includes a curved surface or a flat reflective surface provided at its outer face.

5. A spread illuminating apparatus as claimed in any one of claims 1 to 4, wherein said turn portion is provided with a means for increasing reflection which improves light reflectance.

6. A spread illuminating apparatus as claimed in claim 1, wherein a first optical path conversion means which changes the direction of light rays from the light source and makes the light rays enter said transparent substrate is provided in place of said turn portion separately from said transparent substrate and disposed toward the end surface of said transparent substrate.

7. A spread illuminating apparatus as claimed in claim 6, wherein said first optical path conversion means is provided with a means for increasing reflection which improves light reflectance.

8. A spread illuminating apparatus as claimed in any one of claims 1 to 5, wherein a second optical path conversion means which changes the direction of light rays is provided at an end surface of said turn portion facing said light conductive member.

9. A spread illuminating apparatus as claimed in claim 6 or 7, wherein said second optical path conversion means which changes the direction of light rays is provided at an end surface of said first optical path conversion means facing said light conductive member.
